(19) United States
(12) Patent Application Publication
(10) Pub. No.: US 2016/0344871 A1
(43) Pub. Date: Nov. 24, 2016

(54) METHOD FOR OPTIMIZING COMMUNICATION SERVICES PLANS

(71) Applicant: Zynsight Software Technology, LLC, Birmingham, AL (US)

(72) Inventor: John Close, Birmingham, AL (US)

(73) Assignee: Zynsight Software Technology, LLC, Birmingham, AL (US)

(21) Appl. No.: 15/159,413

(22) Filed: May 19, 2016

Related U.S. Application Data
(60) Provisional application No. 62/163,570, filed on May 19, 2015.

(51) Int. Cl. H04M 15/00

(52) U.S. Cl. CPC H04M 15/43; H04M 15/80; H04M 15/58

(57) ABSTRACT

A software and method for managing services on a tiered communication service plan. The system changes the service level to prevent overage fees and then resets to the lowest plan at the beginning of each month, therefore reducing costs to customers.

### CROSS-REFERENCE TO RELATED APPLICATION

This application claims the benefit of U.S. Provisional Application No. 62/163,570, filed May 19, 2015, which is incorporated herein by reference in its entirety.

### FIELD OF THE INVENTION

The present invention is generally directed toward an internet-enabled automated method for reducing costs of a customer's voice and data plans.

### BACKGROUND OF THE INVENTION

Most providers of communication services, such as cell phone service providers, require customers to select a monthly service plan that accommodates the anticipated monthly volume of data or minutes of talk time. When the customer exceeds the set limit, the service provider will charge significantly higher fees for the usage over the set limit (“overage fees”). The service provider typically offers larger plans that cost more each month, but then the customer will be spending more money in the months where they do not use the services excessively.

In a hypothetical example, a cell phone plan may cost a customer $50 for 1000 minutes of talk time. If the customer exceeds 1000 minutes, each additional minute may be charged at $1 per minute. However, a larger plan of 2000 minutes for $75 per month however may not be practical for the customer.

In an effort to encourage customers to purchase larger plans, many service providers allow the customer to adjust their service plan each month. If the customer knows that he has exceeded his initial set limit, he can change to a larger volume plan in the middle of the month without incurring overage fees. Most service providers hope that the customer will forget to reduce the plan at the end of the billing month, thus incurring higher costs. Therefore, a need exits for a software system that eliminates unused minutes and data for users of cellular service, thus reducing overage fees.

### SUMMARY OF THE INVENTION

We disclose herein a computer implemented method of optimizing communication services plans. Specifically it utilizes an active management system that eliminates unused minutes and data for users of communication services.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The current invention is a software system for reducing excessive costs of communication plans. The software solves the problem of unused minutes and data for users of cellular service by accessing a customer's account on the website of the communication services provider at the beginning of their bill cycle date and lowering the voice and data (plan charges) to the lowest level available to that user. Throughout the billing cycle date and particularly at the end of the bill cycle date, the software checks minute and data usage and matches that usage to the lowest plan to cover usage by backdating the plan to the beginning of the bill cycle date. This eliminates overpaying of service.

In the preferred embodiment of the software system, a customer would first create and register a personal account with the software system by providing personal information, including payment information, their communication service provider, and a username and password. Before gaining access to the system, the customer's personal account must be verified by the customer using an alternate method of identification. In the event the username and password verification fails, the customer will not be registered with the software system. Upon successful verification of the customer's personal account, the customer's personal information will be saved in the system software database.

A potential embodiment of the software system includes sending an email to the customer containing a sample report upon successful registration.

Once the customer has entered the necessary information and accesses the software system, the software uses complex algorithms, usage data, and experience to formulate savings. The software monitors the account in real time, making buying decisions based on current usage before the bill cycle ends. Therefore, the customer will only pay for what is used in the optimal rate configuration.

The software is programmed with rates from major communication providers as well as information required to access each communication provider web page. The software is necessarily adaptable to accommodate changes to the websites of the communication providers and takes into account promotions that may exist from major communications providers.

In addition, the software accumulates historical usage pricing data to determine needs. It also formulates the most efficient pricing structure based on historical, current and future needs.

In other embodiments, the software monitors usage and vendor pricing arrangements on a daily basis. It buys voice minutes and data at the lowest price based on the pricing structure developed. It can also verify that the minutes used are correctly calculated. Other options allow it to report savings in an easy to understand format each month.

More specifically, the software system will indicate to the customers which customers need to change their plans and when. For instance, the software will either indicate that the customer should change his or her plan on the last day of the bill cycle to a higher data and minute usage plan, or that a customer should change their plain on the first day of the bill cycle to lower data and minute usage the plan. Customers can then manually change their plan based on the indication from the software system.

After a certain period of time has elapsed, customers can manually check if their bill was generated and, if so, view data purchased for a specific timeframe, such as a month, data used in that month, and the customer's savings for that month. Additionally, the customer can view his or her savings for the month based on using the software system. The software system also creates a report which is emailed to the customer and saved in the software system database.

A potential embodiment of the software system includes the software system being available to users via a mobile software application.

It should be appreciated that because the software accesses the user's account at the beginning of each billing cycle, the customer does not end up paying for pro-rated charges for changing billing in the middle of the billing cycle. Further advantages will be appreciated from the following hypothetical examples.

### EXAMPLE 1

Customer Chuck has two cell phones and one tablet on his cell account for a contracted amount of 10 GB of service. Two months of the year, the account uses 8-9 GB, and ten months out of the year, it uses under 3 GB. To protect from overage charges Chuck commits for a 10 GB service plan.

Therefore, Chuck is over paying each month on his plan with the exception of the two months of the year that his plan matches his usage.

With the disclosed invention, Chuck would be closely matched to his usage, therefore, saving money on his service.

For example, in Month 1, Chuck used 3 GB, therefore, the software viewed his usage as 3 GB on the last day of his bill cycle. It then raised his plan to 3 GB for that month, matching the plan to his usage. Instead of paying 10 GB and “overpaying” for 7 GB of data, a savings was created between the 10 GB and 3 GB plan. This would create a savings of 30%, for example, by lowering his plan from $100 for that month to $70 that month.

In month 2, the software resets the plan back down to the 1 GB level on the first day of the bill cycle date, and at the end of the bill cycle date, he used 6 GB of data. The software on the last day would purchase the 6 GB plan and backdate the account, thereby saving him from purchasing an extra 4 GB of data. In this case, he would incur a slightly less savings of 15% as he would pay $85 for a 6 GB plan instead of his normal 10 GB plan of $100.

This software resets each month and changes plans before the bill cycle ends, i.e. an “active management” software system. Active management allows users to make changes BEFORE final billing, thereby gaining greater control over their usage and costs associated with that usage.

### EXAMPLE 2

A Tree Service has over 500 units and large pool plans. They were purchasing over 100,000 minutes per month and utilizing in the 50,000 minute range. The problem was that during “storm season”, they would average substantially more minutes hitting in the 90,000 minute range. The storm season lasted 2 months out of 12, but they could not lower plans because of the cost of overages during those months. By using the disclosed system, they tree service could realize significant savings in the month where they did not need the large plans.

Although the system has been described for use with cellular plans, it should be appreciated that it can be used with any tier rate system where usage can be adjusted over the internet. This may include internet service for homes and businesses or wireless internet access in hotspots and airplanes. Also, the customer may include businesses or other group plans. The software may be run over a server, but it is contemplated that it can also be run off of a phone app capable of adjusting rates.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A system for optimizing communication service plans comprising:
a. a software for monitoring minutes of usage on a website of said communication service plan wherein said communication service plan is a tiered plan that allows a customer to adjust the plan level before the bill cycle date without prorated charges;
b. said software adjusts the plan to the lowest rate on the first day of the bill cycle date; and
c. said software adjusts the plan to the lowest rate to accommodate usage without overage.

2. The system of claim 1 wherein said software system is a mobile software application.

3. A method for optimizing customer communication services plans comprising:
a. obtaining communication service plan data; and
b. analyzing said communication service plan data to determine an optimum communication service plan for customer.

4. The method of claim 3 further comprising the step of using a software system to change customer's communication service plan to the optimum communication service plan.

5. The method of claim 3 further comprising the step of notifying customer of the optimum communication service plan.

6. A mobile software application capable of obtaining communication service plan data and notifying customer of an optimum communication service plan.
